(19) United States
(12) Patent Application Publication
(10) Pub. No.: US 2010/0274454 A1
(43) Pub. Date: Oct. 28, 2010

(54) CONTROL DEVICE FOR VEHICLE AND METHOD FOR CONTROLLING VEHICLE

(75) Inventors: Naoki Nishimura, Nagoya-shi (JP); Shigeru Kimura, Toyota-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi, Aichi-ken (JP)

(21) Appl. No.: 12/747,844

(22) PCT Filed: Dec. 2, 2008
(86) PCT No.: PCT/JP2008/071844

§ 371 Date: Jun. 11, 2010

(30) Foreign Application Priority Data
Dec. 14, 2007 (JP) 2007-323337

(51) Int. Cl. G06F 19/00; F16H 61/22

(52) U.S. Cl. 701/54

(57) ABSTRACT

A power supply ECU executes a program including the steps of: transmitting an auto-P request signal if a power switch is in the short pressed state and if a speed V of a vehicle is lower than a predetermined speed α; starting a timer; turning off an IG relay and an ACC relay if a P position signal and an auto-P completion signal are received before a predetermined time period T has elapsed; and maintaining the IG relay and the ACC relay in the ON state if the predetermined time period has elapsed and if the speed V of the vehicle is higher than or equal to the predetermined speed α.

### TECHNICAL FIELD

The present invention relates to a control device for a vehicle on which an internal combustion engine and a transmission provided with a parking lock mechanism are mounted, and in particular, to the stop control of the internal combustion engine in accordance with an actuation state of the parking lock mechanism.

### BACKGROUND ART

Conventionally, an automatic transmission mounted on a vehicle is provided with a parking lock mechanism that limits the rotation of an output shaft of the automatic transmission when a shift position is switched to a parking position. The parking lock mechanism includes a parking lock gear provided on the output shaft side and having a plurality of gear teeth, and a parking lock pole having a protrusion that can mesh with the gear teeth. When the shift position is switched to the parking position, the protrusion meshes with the gear teeth, thereby limiting the rotation of the output shaft.

In a shift switching mechanism that switches the shift position (that will also be referred to as a range in the following description) of an automatic transmission by an actuator in accordance with the driver's operation of a shift lever, a mechanism including a motor (e.g., a DC motor) as a power source for switching the shift position has been known.

According to the shift switching mechanism as described above, there is no need to mechanically connect the shift lever and the shift switching mechanism as in a common switching mechanism that directly switches the shift position of the automatic transmission using operation force applied to the shift lever by a driver. Therefore, there is no limitation in layout when these components are mounted on a vehicle, and thus, the flexibility in design can be enhanced. In addition, there is an advantage that mounting on the vehicle can be readily carried out.

As such shift switching mechanism, Japanese Patent Laying-Open No. 4-69450 (Patent Document 1), for example, discloses a transmission apparatus by electronic control whose operability is improved by controlling a shift actuator in response to operation of an ignition switch or controlling a brake actuator in response to switching of the shift position. This transmission apparatus by electronic control includes: a select switch; calculating means for outputting a control signal in response to an input signal from the select switch; and a shift actuator for switching a shift position of a shift gear in response to the control signal from the calculating means, the calculating means including a shift control unit for controlling the shift actuator to switch the shift position to a parking position in response to an ignition switch.

According to the transmission apparatus by electronic control disclosed in the above publication, movement of the vehicle, which is not intended by the driver, resulting from the switching of the shift position can be prevented before it occurs, without worsening the operability.
Patent Document 1: Japanese Patent Laying-Open No. 4-69450

### DISCLOSURE OF THE INVENTION

### Problems to be Solved by the Invention

When the parking lock mechanism is actuated together with stop of an engine, it takes time to complete actuation of the parking lock mechanism. Therefore, if actuation of the parking lock mechanism is not completed after the engine stops, or if the parking lock mechanism is not actuated for some reasons, the location of the vehicle is fixed dependently on braking force of a brake device. Since gravity is applied to the vehicle on a road surface having an inclination such as an uphill road, in particular, it is required to limit the movement using the braking force of the brake device of the vehicle until actuation of the parking lock mechanism is completed.

In the brake device of the vehicle, however, the operation force applied to the brake pedal by the driver is boosted by using the negative pressure in an intake pipe in the case of a vehicle having a gasoline engine mounted thereon, or the negative pressure by a negative pressure pump actuated by the motive power of the engine in the case of a vehicle having a diesel engine mounted thereon. Therefore, if the engine stops before the parking lock mechanism is actuated, the sufficient brake performance cannot be ensured in some cases. Thus, the vehicle moves contrary to the driver's intention.

The present invention has been made to solve the above-described problems, and an object thereof is to provide a control device for a vehicle and a method for controlling a vehicle that suppress the movement of the vehicle contrary to the driver's intention.

### Means for Solving the Problems

A control device for a vehicle according to an aspect of the present invention is a control device for a vehicle on which an internal combustion engine and a transmission provided with a parking lock mechanism are mounted. The parking lock mechanism switches between limitation of rotation of a shaft coupled to a driving wheel of the vehicle and release of the limitation, by using a gear mechanism driven by an actuator based on an electrical signal corresponding to a state of an operation member. The control device includes: a detecting unit for detecting a physical amount related to an actuation state of the parking lock mechanism; and a control unit for receiving an output from the detecting unit. The control unit determines whether or not an instruction to stop the internal combustion engine has been received, based on the electrical signal, determines whether or not the rotation of the shaft is limited based on the physical amount detected, when receiving the instruction to stop the internal combustion engine, maintains the internal combustion engine in an actuated state, when determining that the rotation of the shaft is not limited, and stops the internal combustion engine, when determining that the rotation of the shaft is limited.

According to the first invention, even when the instruction to stop the internal combustion engine is received, the internal combustion engine is maintained in the actuated state if it is determined that the rotation of the shaft is not limited. This allows suppression of stop of the internal combustion engine before actuation of the parking lock mechanism is completed. Therefore, degradation in brake performance due to the stop of the internal combustion engine can be suppressed. For example, even when the vehicle moves during parking of the vehicle on a road surface having an inclination and during actuation of the parking lock mechanism after the instruction to stop the internal combustion engine is received, the location of the vehicle can be fixed by the driver's operation of a brake, to suppress the movement of the vehicle which is not intended by the driver. In addition, when actuation of the parking lock mechanism is completed, the movement of the vehicle can be adapted to the driver's intention by stopping the internal combustion engine. Accordingly, there can be provided a control device for a vehicle and a method for controlling a vehicle that suppress the movement of the vehicle contrary to the driver's intention.

Preferably, the detecting unit detects a speed of the vehicle. The control unit determines that the rotation of the shaft is not limited, when the speed of the vehicle detected is higher than or equal to a predetermined speed.

According to the present invention, when the speed of the vehicle detected is higher than or equal to the predetermined speed, it can be determined that the rotation of the shaft is not limited, that is, actuation of the parking lock mechanism is not completed.

More preferably, the parking lock mechanism includes a gear provided at the shaft, and a member for limiting rotation of the gear or releasing limiting rotation of the gear. The detecting unit detects a location of the member. The control unit determines that the rotation of the shaft is not limited, when the location detected is not a location where the rotation of the gear is limited.

According to the present invention, when the location of the member for limiting the rotation of the gear or releasing limiting the rotation of the gear is not the location where the rotation of the gear is limited, it can be determined that the rotation of the shaft is not limited, that is, actuation of the parking lock mechanism is not completed.

More preferably, the actuator is a rotating electric machine driven by receiving electric power feed from a power supply. The detecting unit detects electric power of the power supply. The control unit determines that the rotation of the shaft is not limited, when the electric power detected is not electric power that allows driving of the actuator.

According to the present invention, when the electric power detected is not the electric power that allows driving of the actuator, the parking lock mechanism cannot be actuated, and thus, it can be determined that the rotation of the shaft is not limited.

More preferably, the control unit starts up the internal combustion engine at a standstill.

According to the present invention, when the internal combustion engine is at a standstill, degradation in performance of the brake using the negative pressure based on actuation of the internal combustion engine can be suppressed by starting up the internal combustion engine.

More preferably, the control device further includes a notifying unit for notifying an occupant of the vehicle that the internal combustion engine is maintained in the actuated state, when it is determined that the rotation of the shaft is not limited.

According to the present invention, by notifying the occupant of the vehicle that the internal combustion engine is maintained in the actuated state, the occupant of the vehicle can recognize that the internal combustion engine cannot be stopped because actuation of the parking lock mechanism is not completed, and can be encouraged to actuate a brake device.

More preferably, the control unit determines whether or not an instruction to forcibly stop the internal combustion engine has been received, based on the electrical signal, and stops the internal combustion engine when receiving the instruction to forcibly stop the internal combustion engine.

According to the present invention, the internal combustion engine can be forcibly stopped in accordance with the driver's intention.

More preferably, the state of the operation member is a state based on a time period during which operation of the operation member continues.

According to the present invention, by changing the time period during which operation of the operation member continues, the driver can select the manner of stop of the internal combustion engine that is adapted to the driver's intention, such as forced stop of the internal combustion engine, stop of the internal combustion engine after actuation of the parking lock mechanism is completed, or the like.

More preferably, the control device further includes a state detecting unit for detecting a traveling state of the vehicle. The control unit receives an output from the state detecting unit, determines whether or not the vehicle is at a standstill, based on the traveling state detected, and stops the internal combustion engine when determining that the rotation of the shaft is not limited and the vehicle is at a standstill.

According to the present invention, when it is determined that the vehicle is at a standstill, the location of the vehicle is in a fixed state. Therefore, the movement of the vehicle can be adapted to the driver's intention by stopping the internal combustion engine regardless of the actuation state of the parking lock mechanism.

More preferably, the state detecting unit detects a speed of the vehicle. The control unit determines that the vehicle is at a standstill, when the speed of the vehicle detected is lower than a predetermined speed after a predetermined time period has elapsed from a point in time at the earliest when the instruction to stop the internal combustion engine was received.

According to the present invention, when the speed of the vehicle is lower than the predetermined speed after the predetermined time period has elapsed from the point in time at the earliest when the instruction to stop the internal combustion engine was received, the location of the vehicle is in the fixed state. Therefore, the movement of the vehicle can be adapted to the driver's intention by stopping the internal combustion engine regardless of the actuation state of the parking lock mechanism.

More preferably, the parking lock mechanism includes a parking lock gear provided at the shaft and having a gear tooth along a direction of rotation, a parking lock pole supported by a case of the transmission and having a protrusion that meshes with the gear tooth, and a limiting unit for limiting the rotation of the shaft by meshing the gear tooth and the protrusion of the parking lock pole in accordance with driving of the actuator.

According to the present invention, when it is determined that the rotation of the shaft is not limited based on the physical amount related to the actuation state of the parking lock mechanism, the internal combustion engine is maintained in the actuated state and degradation in brake performance can be suppressed.

More preferably, a brake device for producing braking force by using a negative pressure generated as a result of actuation of the internal combustion engine is mounted on the vehicle.

According to the present invention, when it is determined that the rotation of the shaft is not limited based on the physical amount related to the actuation state of the parking lock mechanism, the internal combustion engine is maintained in the actuated state, and degradation in performance of the brake using the negative pressure generated as a result of actuation of the internal combustion engine can be suppressed.

### BRIEF DESCRIPTION OF THE DRAWINGS

FIG. 1 illustrates a configuration of a vehicle on which a control device for the vehicle according to the present embodiment is mounted.

FIG. 2 illustrates a configuration of a shift switching mechanism in FIG. 1.

FIG. 3 illustrates a configuration of a parking lock mechanism.

FIG. 4 is a functional block diagram of a power supply ECU and an SBW-ECU.

FIG. 5 is a flowchart illustrating a control structure of a program running on the power supply ECU.

FIG. 6 is a flowchart illustrating a control structure of a program running on the SBW-ECU.

### DESCRIPTION OF THE REFERENCE SIGNS

10 shift control system; 20 shift operation unit; 22 P switch; 24 shift switch; 30 automatic transmission; 32 engine; 40 actuator unit; 42 actuator; 44 output shaft sensor; 46 encoder; 48 shift switching mechanism; 50 SBW-ECU; 52 ECT-ECU; 54 EFI-ECU; 56 VSC-ECU; 58 meter; 60 power supply ECU; 62 power switch; 64 vehicle speed sensor; 66 power supply relay; 68 IG relay; 70 ACC relay; 72 brake device; 74 angle sensor; 76 voltmeter; 78 power supply; 100 detent plate; 102 shaft; 104 rod; 106 parking lock pole; 108 parking lock gear; 110 detent spring; 112 roller; 120 location of the non-P position; 122 crest; 124 location of the P position; 160 non-P wall; 162 P wall; 200 parking lock mechanism; 204 gear tooth; 208 protrusion; 210 parking lock cam; 212 shaft; 300, 550 input I/F; 350, 600 processing unit; 352 operation determining unit; 354 vehicle speed determining unit; 356 auto-P request transmitting unit; 358 timer unit; 360 stop condition determining unit; 362 relay driving unit; 400, 650 communicating unit; 402 communication line; 450, 700 storage unit; 500, 750 output I/F; 602 request determining unit; 604 actuator driving unit; 606 position signal updating unit; 608 vehicle speed determining unit; 610 completion/non-completion signal transmitting unit

### BEST MODES FOR CARRYING OUT THE INVENTION

Embodiments of the present invention will be described hereinafter with reference to the drawings. In the following description, the same components are denoted with the same reference characters. Their names and functions are also the same. Thus, detailed description on them will not be repeated.

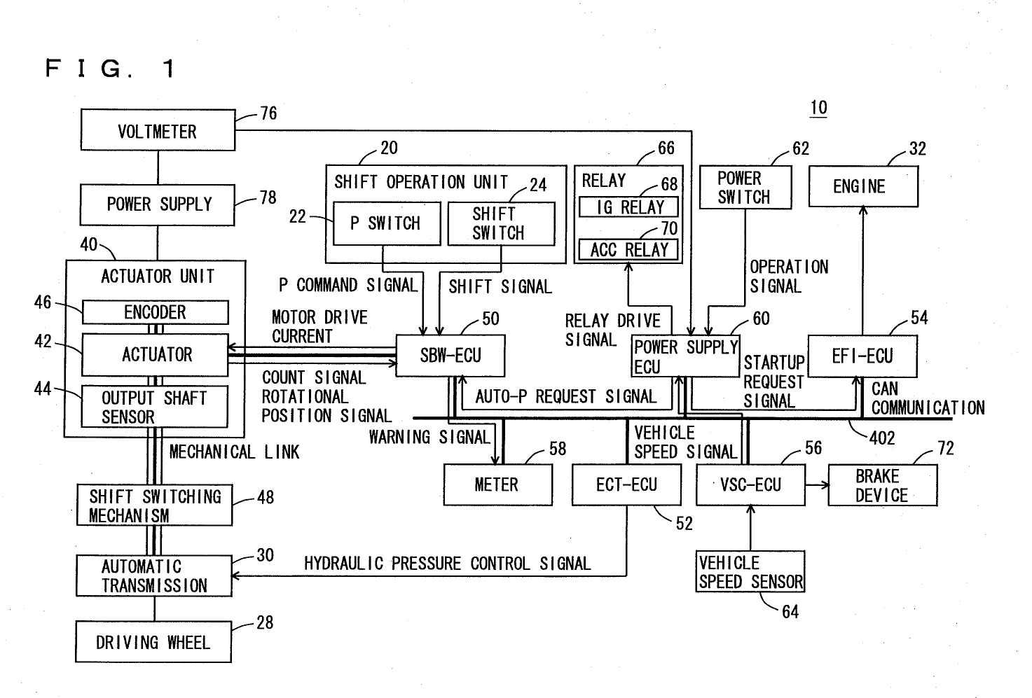

FIG. 1 illustrates a configuration of a shift control system 10 including a control device for a vehicle according to the present embodiment. Shift control system 10 according to the present embodiment is used to switch the shift position of the vehicle. Shift control system 10 includes a shift operation unit 20, an actuator unit 40, a shift switching mechanism 48, an automatic transmission 30, an engine 32, an SBW (Shift By Wire)-ECU (Electronic Control Unit) 50, an ECT (Electronic Controlled Automatic Transmission)-ECU 52, an EFI (Electronic Fuel Injection)-ECU 54, a VSC (Vehicle Stability Control)-ECU 56, a meter 58, a power supply ECU 60, a power switch 62, a vehicle speed sensor 64, a power supply relay 66, and a brake device 72. The control device for the vehicle according to the present embodiment is implemented by power supply ECU 60.

SBW-ECU 50, ECT-ECU 52, EFI-ECU 54, VSC-ECU 56, meter 58, and power supply ECU 60 are mutually connected by a communication line (bus) 402, and data transfer between the vehicle-mounted equipment is implemented by the CAN (Controller Area Network) communication.

Shift operation unit 20 is configured by a P switch 22 and a shift switch 24. Actuator unit 40 is configured by an actuator 42, an output shaft sensor 44 and an encoder 46. Power supply relay 66 includes an IG relay 68 and an ACC relay 70.

In the configuration as described above, shift control system 10 functions as a shift by wire system that switches the shift position by electric control. Specifically, shift switching mechanism 48 is driven by actuator 42 to switch the shift position.

P switch 22 is for switching the shift position between the parking position (that will be described as “P position” hereinafter) and the shift position other than the parking position (that will be described as “non-P position” hereinafter), and includes an indicator for indicating the state of the switch to the driver and an input unit for accepting an instruction from the driver (both are not shown). The driver inputs an instruction to place the shift position in the P position, through the input unit. The input unit may be a momentary switch. A P command signal indicating the instruction from the driver that is accepted by the input unit is transmitted to SBW-ECU 50. It is noted that, in the present embodiment, SBW-ECU 50 switches the shift position from the non-P position to the P position in response to a request from power supply ECU 60, except for such P switch 22.

In order to switch the shift position between the P position and the non-P position, SBW-ECU 50 controls the operation of actuator 42 that drives shift switching mechanism 48, and presents the state of the current shift position to an indicator (not shown) of meter 58. When the driver presses the input unit of P switch 22 or when SBW-ECU 50 receives an auto-P request signal from power supply ECU 60, with the shift position in the non-P position, SBW-ECU 50 switches the shift position to the P position and presents to the indicator that the current shift position is in the P position. It is noted that, when the speed of the vehicle is higher than or equal to a predetermined speed α, SBW-ECU 50 does not switch the shift position to the P position.

Actuator 42 is configured by a switched reluctance motor (that will be described as “SR motor” hereinafter), and receives an actuator control signal from SBW-ECU 50 and drives shift switching mechanism 48.

Encoder 46 rotates integrally with actuator 42 and detects the situation of the rotation of the SR motor. Encoder 46 in the present embodiment is a rotary encoder that outputs signals of an A phase, a B phase and a Z phase. SBW-ECU 50 grasps the situation of the rotation of the SR motor by obtaining the signal output from encoder 46, and controls conduction for driving the SR motor.

Shift switch 24 is for switching the shift position to the position such as a forward drive position (that will be described as “D position” hereinafter), a rearward drive position (that will be described as “R position” hereinafter) and a neutral position (that will be described as “N position” hereinafter), or for clearing the selection of the P position when the shift position is in the P position. A switching signal (that will also be referred to as a shift signal hereinafter) indicating an instruction from the driver that is accepted by shift switch 24 is transmitted to SBW-ECU 50. In other words, shift switch 24 transmits, to SBW-ECU 50, the shift signal indicating the shift position corresponding to the location of an operation member (e.g., shift lever) operated by the driver. SBW-ECU 50 exercises control for switching the shift position in automatic transmission 30 by actuator 42 based on the shift signal indicating the instruction from the driver, and in addition, presents the state of the current shift position to meter 58.

More specifically, when the shift position corresponding to the location of the shift lever based on the shift signal received from shift switch 24 is different from the shift position based on the rotational position and the amount of rotation of actuator 42 detected by output shaft sensor 44, encoder 46 and the like, SBW-ECU 50 drives actuator 42 to switch to the shift position corresponding to the location of the shift lever. In the present embodiment, when the switched shift position is in the P position, SBW-ECU 50 transmits, to power supply ECU 60, a P position signal indicating that the shift position has been switched to the P position. In addition, when the switched shift position is in the non-P position, SBW-ECU 50 transmits, to power supply ECU 60, a non-P position signal indicating that the shift position has been switched to the non-P position.

Although automatic transmission 30 is described as a gear type automatic transmission in the present embodiment, automatic transmission 30 is not particularly limited thereto, but may be, for example, a continuously variable automatic transmission.

Automatic transmission 30 is provided with a hydraulic circuit including various valves such as a manual valve, for example, and a change in the hydraulic pressure in the hydraulic circuit causes a change in the shift position and the motive power transfer state. More specifically, automatic transmission 30 is provided with a planetary gear mechanism as well as a frictional engagement element such as a brake element and a clutch element that changes the manner of rotation of each rotation element (i.e., a sun gear, a carrier, a ring gear and the like) of the planetary gear mechanism.

A spool valve is provided in the manual valve to slide therein. When the spool valve is moved to the location corresponding to each shift position, the hydraulic pressure in the hydraulic circuit changes in accordance with the location to which the spool valve is moved.

At this time, engagement force in the frictional engagement element changes in accordance with the change in the hydraulic pressure in the hydraulic circuit, and automatic transmission 30 changes to the state corresponding to each shift position. In other words, the state of motive power transfer from engine 32 to a driving wheel in automatic transmission 30 (e.g., any state of forward movement, rearward movement and motive power interruption, or a gear ratio) changes. The engagement force in this frictional engagement element is controlled by ECT-ECU 52 by using various solenoid valves provided at the hydraulic circuit.

Shift switching mechanism 48 includes a shaft coupled to actuator 42. The shaft is provided with a detent plate that will be described later.

It is noted that the detent plate may be coupled to the spool valve of the manual valve of automatic transmission 30 with a rod and the like interposed therebetween. The shaft is rotated by actuator 42.

Although actuator 42 is described as a rotationally driven motor in the present embodiment, actuator 42 is not particularly limited thereto, but may be, for example, a linearly driven motor. In addition, actuator 42 is not particularly limited to a motor.

Output shaft sensor 44 detects the rotational position of a shaft 102. Specifically, output shaft sensor 44 is connected to SBW-ECU 50 and transmits a signal (rotational position signal) indicating the rotation angle of shaft 102 to SBW-ECU 50. SBW-ECU 50 detects the shift position based on the received signal indicating the rotational position. A predetermined range of an output value corresponding to each shift position is set in a memory of SBW-ECU 50. SBW-ECU 50 determines the currently selected shift position by determining which range corresponding to each shift position the received signal indicating the rotation angle of shaft 102 corresponds to. In addition, in the present embodiment, it is assumed that a change in the output value of output shaft sensor 44 has a linear relationship with respect to a change in the rotational position (angle) of shaft 102. Output shaft sensor 44 is for detecting the rotation angle of shaft 102 that is the physical amount corresponding to the amount of actuation of actuator 42.

Engine 32 is an internal combustion engine and transfers an output generated by combustion to an input shaft of automatic transmission 30. The output of engine 32 is controlled by EFI-ECU 54.

Power switch 62 is for starting up or stopping engine 32. A signal indicating an operation state that is accepted by power switch 62 from a vehicle's occupant such as the driver is transmitted to power supply ECU 60. In response to the operation signal from power switch 62, power supply ECU 60 turns off power supply relay 66 or transmits a signal for requesting startup of engine 32 to EFI-ECU 54. When receiving the signal for requesting startup of engine 32 from power supply ECU 60, EFI-ECU 54 starts up engine 32. Specifically, fuel injection control over a fuel injection injector and ignition control over an ignition plug are exercised, together with cranking by a starter (not shown).

Vehicle speed sensor 64 detects the physical amount corresponding to the speed of the vehicle. For example, vehicle speed sensor 64 may detect the rotation speed of the wheel, or may detect the rotation speed of the output shaft of automatic transmission 30. Alternatively, vehicle speed sensor 64 may directly detect the speed of the vehicle by using the GPS (Global Positioning System) and the like.

In the present embodiment, vehicle speed sensor 64 is connected to VSC-ECU 56, and transmits a signal indicating the detected speed of the vehicle to VSC-ECU 56. VSC-ECU 56 transmits, to power supply ECU 60, the signal indicating the speed of the vehicle that is received from vehicle speed sensor 64.

It is noted that vehicle speed sensor 64 may be directly connected to power supply ECU 60, or may be connected to at least any one of SBW-ECU 50, ECT-ECU 52, EFI-ECU 54, and VSC-ECU 56.

In addition to the oil temperature, ECT-ECU 52 controls the shift state of automatic transmission 30 based on the physical amount related to the state of automatic transmission 30 (e.g., the rotation speed of a turbine, the rotation speed of the output shaft and the rotation speed of the engine).

In addition to the opening degree of an accelerator, EFI-ECU 54 controls the output of engine 32 based on the physical amount related to the state of the engine (e.g., the water temperature, the amount of intake air and the like).

In addition to the master cylinder pressure, VSC-ECU 56 controls the brake hydraulic pressure in brake device 72 based on the physical amount related to the behavior of the vehicle (e.g., wheel speed).

Meter 58 presents the state of the vehicle equipment, the state of the shift position and the like. Meter 58 is provided with a display unit (not shown) that displays an instruction, a warning and the like to the driver issued by SBW-ECU 50 or power supply ECU 60.

Brake device 72 causes the wheel to produce the braking force by using the negative pressure generated as a result of actuation of engine 32. For example, brake device 72 includes a brake pedal, a vacuum booster coupled to the brake pedal, a master cylinder coupled to the vacuum booster, a hydraulic circuit including a brake actuator and the like, and a disc brake provided at the wheel.

If engine 32 is a gasoline engine, an intake pipe of engine 32 is coupled to the vacuum booster. The operation force applied to the brake pedal by the driver is boosted in the vacuum booster by using the negative pressure generated at the intake pipe when engine 32 is actuated, and is transferred to the master cylinder.

If engine 32 is a diesel engine, the vacuum booster is coupled to the vacuum pump actuated by the motive power of engine 32. The operation force applied to the brake pedal by the driver is boosted in the vacuum booster by using the negative pressure generated at the negative pressure pump when engine 32 is actuated, and is transferred to the master cylinder.

When the operation signal received from power switch 62 is a signal corresponding to an instruction to start up engine 32, power supply ECU 60 transmits a relay drive signal to power supply relay 66 to turn on IG relay 68 and ACC relay 70, and in addition, transmits the signal for requesting startup of engine 32 to EFI-ECU 54.

In addition, when the operation signal received from power switch 62 is a signal corresponding to an instruction to stop engine 32, power supply ECU 60 transmits the relay drive signal to power supply relay 66 to turn off at least IG relay 68. It is noted that power supply ECU 60 may drive power supply relay 66 based on the operation state of the brake pedal and/or the operation state of the shift lever, in addition to the operation signal from power switch 62.

In response to the relay drive signal from power supply ECU 66, power supply relay 66 turns on only ACC relay 70, turns on IG relay 68 after turning on ACC relay 70, turns off only IG relay 68, or turns off ACC relay 70 after turning off IG relay 68. When IG relay 68 is turned on, electric power is supplied to the vehicle-mounted equipment actuated at least in association with startup of engine 32.

Power supply ECU 60 transmits the relay drive signal corresponding to on and off combinations of IG relay 68 and ACC relay 70 to power supply relay 66, in accordance with the actuation state of the engine and the operation state of power switch 62.

The operation state of power switch 62 is a state based on a time period during which the operation of power switch 62 continues. Specifically, the operation state is a state based on a time period during which a button serving as an input portion of power switch 62 is pressed.

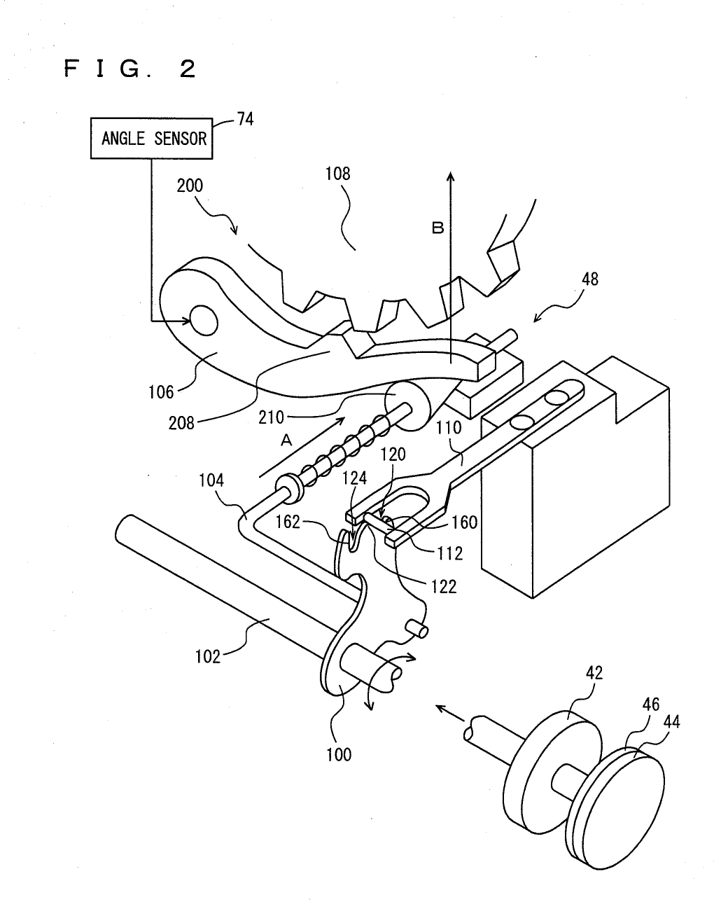

FIG. 2 illustrates a configuration of shift switching mechanism 48. Although the shift position is described hereinafter as the one that means the P position and the non-P position and that does not include each of the R, N and D positions in the non-P position, the shift position may include each of the R, N and D positions. In other words, although a configuration of the two positions, that is, the P position and the non-P position is described in the present embodiment, the present invention may have a configuration of the four positions, that is, the P position and the non-P position including each of the R, N and D positions.

Shift switching mechanism 48 includes shaft 102 rotated by actuator 42, a detent plate 100 rotated with the rotation of shaft 102, a rod 104 operated with the rotation of detent plate 100, a parking lock gear 108 fixed to the not-shown output shaft of automatic transmission 30, a parking lock pole 106 for locking parking lock gear 108, a detent spring 110 for limiting the rotation of detent plate 100 and fixing the shift position, and a roller 112. Detent plate 100 is driven by actuator 42 and switches the shift position. In addition, encoder 46 functions as counting means for obtaining a count corresponding to the amount of rotation of actuator 42. Furthermore, output shaft sensor 44 detects the rotational position of shaft 102.

FIG. 2 illustrates the state in which the shift position is in the non-P position. In this state, parking lock pole 106 does not lock parking lock gear 108, and thus, the rotation of the drive shaft of the vehicle is not limited. If shaft 102 is turned clockwise from this state by actuator 42, rod 104 is pushed by detent plate 100 in the direction of an arrow A shown in FIG. 2, and parking lock pole 106 is pushed up by a tapered parking lock cam 210 provided at the tip of rod 104, in the direction of an arrow B shown in FIG. 2. With the rotation of detent plate 100, roller 112 of detent spring 110 situated in one of the two troughs provided at the top of detent plate 100, that is, in a location 120 of the non-P position, climbs over a crest 122 and moves to the other trough, that is, to a location 124 of the P position. Roller 112 is provided at detent spring 110 to be capable of rotating in the axial direction of roller 112. When detent plate 100 rotates until roller 112 reaches location 124 of the P position, parking lock pole 106 is pushed up to the location where a protrusion 208 of parking lock pole 106 meshes with a region between the gear teeth of parking lock gear 108. As a result, the rotation of the drive shaft of the vehicle is mechanically limited and the shift position is switched to the P position.

In shift control system 10 according to the present embodiment, in order to reduce the load applied to the components of shift switching mechanism 48 such as detent plate 100, detent spring 110 and shaft 102 at the time of switching the shift position, SBW-ECU 50 controls the amount of rotation of actuator 42 to lessen the impact when roller 112 of detent spring 110 climbs over crest 122 and falls.

A plane located on the side distant from crest 122 in each trough of detent plate 100 is referred to as a wall. In other words, the wall is in the location where roller 112 hits the wall when roller 112 of detent spring 110 climbs over crest 122 and falls to the trough without control by SBW-ECU 50 that will be described hereinafter. The wall in location 124 of the P position is referred to as a P wall 162, and the wall in location 120 of the non-P position is referred to as a non-P wall 160.

Although a configuration in which a parking lock mechanism 200 is provided within automatic transmission 30 is described in the present embodiment, parking lock mechanism 200 may be provided in any location if parking lock mechanism 200 is provided at the rotation shaft between the driving wheel and automatic transmission 30.

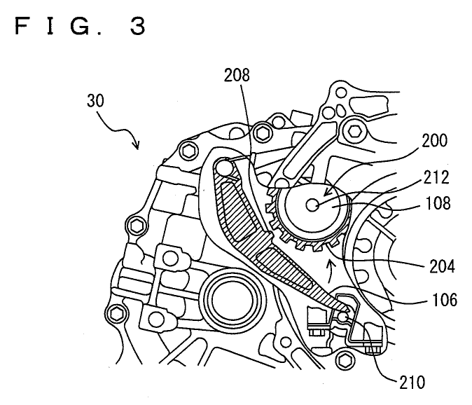

Parking lock mechanism 200 includes parking lock gear 108 and parking lock pole 106 as shown in FIG. 3. In the present embodiment, parking lock gear 108 may be provided at the output shaft of automatic transmission 30, or may be provided at a shaft of the gear engaged with the output shaft. Parking lock gear 108 has a disc shape and is provided with a plurality of gear teeth 204 along the direction of rotation of a shaft 212.

Parking lock pole 106 is supported by a case of automatic transmission 30 such that one end thereof can be freely rotated. Protrusion 208 meshing with gear teeth 204 of parking lock gear 108 is provided in the center of parking lock pole 106. At the other end of parking lock pole 106, parking lock cam 210 is provided to abut parking lock pole 106. Parking lock cam 210 has, for example, a conical shape and when parking lock cam 210 moves from the back side to the front side of the sheet in FIG. 3, the other end of parking lock pole 106 rotationally moves in the direction of an arrow in

FIG. 3 along a sloped portion of the conical shape. In accordance with the movement of the shift lever (not shown) to the location corresponding to the P position, parking lock cam 210 moves from the back side to the front side of the sheet in FIG. 3. At this time, parking lock cam 210 is actuated by the rotation of detent plate 100 caused by driving of actuator 42. When protrusion 208 of parking lock pole 106 moves, as a result of driving of parking lock cam 210, to the predetermined location where protrusion 208 meshes with gear teeth 204 of parking lock gear 108, the rotation of parking lock gear 108 is limited. Parking lock mechanism 200 is actuated in such a manner, thereby limiting the rotation of the driving wheel.

In the configuration of the vehicle as described above, power supply ECU 60 serving as the control device for the vehicle according to the present embodiment has the following feature. When receiving the instruction to stop engine 32, power supply ECU 60 determines whether or not the rotation of parking lock gear 108 is limited, based on the physical amount related to the actuation state of parking lock mechanism 200. When determining that the rotation of parking lock gear 108 is not limited, power supply ECU 60 maintains engine 32 in the actuated state. When determining that the rotation of parking lock gear 108 is limited, power supply ECU 60 stops engine 32.

Specifically, when the speed of the vehicle received from vehicle speed sensor 64 via VSC-ECU 56 is higher than or equal to predetermined speed α, power supply ECU 60 determines that the rotation of parking lock gear 108 is not limited. When determining that the rotation of parking lock gear 108 is not limited, power supply ECU 60 maintains IG relay 68 in the ON state, thereby maintaining engine 32 in the actuated state.

It is noted that, when engine 32 is at a standstill, power supply ECU 60 may turn on both IG relay 68 and ACC relay 70 and transmit the signal for requesting startup of engine 32 to EFI-ECU 54.

Furthermore, when determining that the rotation of parking lock gear 108 is not limited, power supply ECU 60 transmits a warning signal to meter 58 to notify the vehicle's occupant that engine 32 is maintained in the actuated state. In meter 58, a warning lamp corresponding to the received warning signal lights up to notify the vehicle's occupant that engine 32 is maintained in the actuated state.

In addition, when receiving an instruction to forcibly stop engine 32, power supply ECU 60 turns off IG relay 68, thereby stopping engine 32.

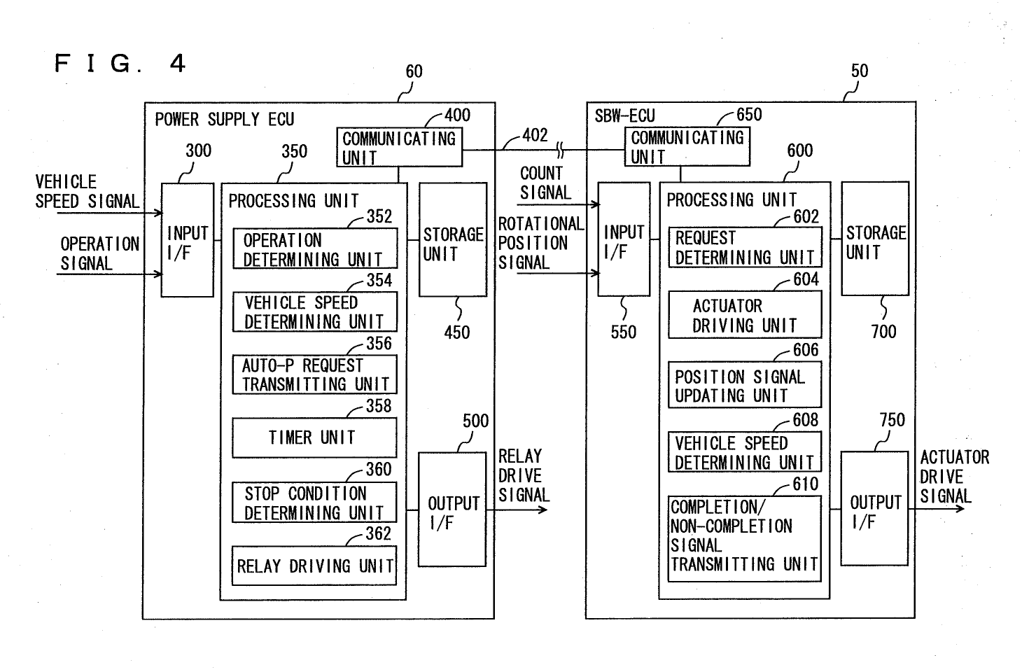

FIG. 4 shows a functional block diagram of power supply ECU 60 and SBW-ECU 50. Power supply ECU 60 includes an input interface (that will be described as an input I/F hereinafter) 300, a processing unit 350, a communicating unit 400, a storage unit 450, and an output interface (that will be described as an output I/F hereinafter) 500.

Input I/F 300 receives the operation signal from power switch 62 and a vehicle speed signal from VSC-ECU 56, and transmits the signals to processing unit 350.

Processing unit 350 includes an operation determining unit 352, a vehicle speed determining unit 354, an auto-P request transmitting unit 356, a timer unit 358, a stop condition determining unit 360, and a relay driving unit 362.

Communicating unit 400 is connected to a communicating unit 650 of SBW-ECU 50 by communication line 402. Communicating unit 400 receives an auto-P completion signal and an auto-P non-completion signal from SBW-ECU 50, and transmits the signals to processing unit 350. In addition, communicating unit 400 transmits, to communicating unit 650, the auto-P request signal received from auto-P request transmitting unit 356. Furthermore, communicating unit 400 transmits, to communicating unit 650, the vehicle speed signal received from input I/F 300 via processing unit 350.

Operation determining unit 352 determines whether the operation state of power switch 62 is the operation state corresponding to the instruction to stop engine 32, or the operation state corresponding to the instruction to forcibly stop engine 32, based on the operation signal received via input I/F 300.

It is noted that operation determining unit 352 does not determine only the above operation states. In addition to the above operation states, operation determining unit 352 may determine whether the operation state of power switch 62 is the operation state corresponding to the instruction to start up engine 32, or the operation state corresponding to an instruction to effect a transition to the power supply position of an accessory (ACC). Furthermore, in addition to the operation state of power switch 62, operation determining unit 352 may determine the presence or absence of the instruction from the driver based on the location of the brake pedal and/or the shift lever.

Operation determining unit 352 uses a timer to measure a time period that has elapsed since the operation signal indicating that the button of the input portion of power switch 62 was pressed was received. When the measured elapsed time period, that is, the time period during which the button is pressed is longer than or equal to a predetermined time period (1) and within a predetermined time period (2), operation determining unit 352 determines that the operation state of power switch 62 is the operation state corresponding to the instruction to stop engine 32. Predetermined time period (2) is longer than predetermined time period (1).

Furthermore, when the time period during which the button is pressed is longer than a predetermined time period (3), operation determining unit 352 determines that the operation state of power switch 62 is the operation state corresponding to the instruction to forcibly stop engine 32. Predetermined time period (3) is at least longer than or equal to predetermined time period (2).

It is noted that operation determining unit 352 may turn on a stop instruction determination flag when the operation state of power switch 62 is the operation state corresponding to the instruction to stop engine 32, and may turn on a forced stop instruction determination flag when the operation state of power switch 62 is the operation state corresponding to the instruction to forcibly stop engine 32.

Vehicle speed determining unit 354 determines whether or not a speed V of the vehicle is lower than predetermined speed α, based on the vehicle speed signal. Predetermined speed α is not particularly limited if predetermined speed α is the speed of the vehicle at which it can be determined that the vehicle is substantially at a standstill. For example, predetermined speed α is 4 km per hour. It is noted that, when determining that speed V of the vehicle is lower than predetermined speed α, vehicle speed determining unit 354 may turn on a vehicle stop determination flag.

When the operation state of power switch 62 is the operation state corresponding to the instruction to stop engine 32 and speed V of the vehicle is lower than predetermined speed α, auto-P request transmitting unit 356 transmits the auto-P request signal indicating a request to exercise auto-P control, to SBW-ECU 50 via communicating unit 400 and communication line 402. It is noted that, in the present embodiment, “auto-P control” refers to control in which the stop control of engine 32 and the drive control of the actuator for changing the shift position to the P position are simultaneously exercised.

Timer unit 358 measures a time period that has elapsed since the auto-P request signal was transmitted. It is noted that timer unit 358 may only measure a time period that has elapsed from the point in time at the earliest when the operation state of power switch 62 was determined as the operation state corresponding to the instruction to stop engine 32.

Stop condition determining unit 360 determines whether or not the condition for stopping engine 32 is satisfied. The condition for stopping engine 32 includes the condition that the elapsed time period measured by timer unit 358 becomes longer than or equal to a predetermined time period T and the condition that the P position signal and the auto-P completion signal are received from SBW-ECU 50. When the condition for stopping engine 32 is satisfied, for example, stop condition determining unit 360 may turn on a stop condition satisfaction flag.

When the condition for stopping engine 32 is satisfied, relay driving unit 362 transmits the relay drive signal to power supply relay 66 via output I/F 500 to turn off IG relay 68 and ACC relay 70. It is noted that, when the stop instruction determination flag and the stop condition satisfaction flag are both ON, for example, relay driving unit 362 may drive power supply relay 66 to turn off relay 68 and ACC relay 70.

In addition, when the operation state of power switch 62 is determined as the operation state corresponding to the instruction to forcibly stop engine 32, relay driving unit 362 transmits the relay drive signal to power supply relay 66 via output I/F 500 to turn off IG relay 68 and maintain ACC relay 70 in the ON state. When the forced stop instruction determination flag is ON, for example, relay driving unit 362 may drive power supply relay 66 to turn off IG relay 68 and maintain ACC relay 70 in the ON state.

Furthermore, when speed V of the vehicle is lower than predetermined speed α and the position signal is not the P position signal after predetermined time period T or longer has elapsed since the auto-P request signal was transmitted, relay driving unit 362 transmits the relay drive signal to power supply relay 66 via output I/F 500 to turn off IG relay 68 and maintain ACC relay 70 in the ON state.

It is noted that, when the vehicle speed determination flag is ON and the position signal is not the P position signal after predetermined time period T or longer has elapsed since the auto-P request signal was transmitted, for example, relay driving unit 362 may drive power supply relay 66 to turn off IG relay 68 and maintain ACC relay 70 in the ON state.

In addition, when the operation state of power switch 62 does not correspond to any of the instruction to stop engine 32 and the instruction to forcibly stop engine 32, or when speed V of the vehicle is higher than or equal to predetermined speed α, relay driving unit 362 maintains IG relay 68 and ACC relay 70 in the ON state. It is noted that, when the vehicle speed determination flag, the stop instruction determination flag and the forced stop instruction determination flag are all OFF, for example, relay driving unit 362 may drive power supply relay 66 to maintain IG relay 68 and ACC relay 70 in the ON state.

Although, in the present embodiment, operation determining unit 352, vehicle speed determining unit 354, auto-P request transmitting unit 356, timer unit 358, stop condition determining unit 360, and relay driving unit 362 are all described as those functioning as software that are implemented by a CPU (Central Processing Unit), which is processing unit 350, executing a program stored in storage unit 450, they may be implemented by hardware. It is noted that such program is stored in a recording medium and mounted on the vehicle.

Various information, a program, a threshold value, a map and the like are stored in storage unit 450, and read from processing unit 350 as required.

SBW-ECU 50 includes an input I/F 550, a processing unit 600, a communicating unit 650, a storage unit 700, and an output I/F 750.

Input I/F 550 receives a count signal from encoder 46 and the rotational position signal from output shaft sensor 44, and transmits the signals to processing unit 600.

Processing unit 600 includes a request determining unit 602, an actuator driving unit 604, a position signal updating unit 606, a vehicle speed determining unit 608, and a completion/non-completion signal transmitting unit 610.

Request determining unit 602 determines the presence or absence of the request to exercise the auto-P control. When communicating unit 650 receives the auto-P request signal from power supply ECU 60 via communication line 402, request determining unit 602 determines that the request to exercise the auto-P control is present. It is noted that, when determining that the request to exercise the auto-P control is present, for example, request determining unit 602 may turn on an exercise request determination flag.

When the request to exercise the auto-P control is present, actuator driving unit 604 drives actuator 42 such that the shift position is switched to the P position, that is, roller 112 moves to location 124 of the P position based on the count signal and the rotational position signal. Specifically, actuator driving unit 604 generates an actuator drive control signal based on the count signal and the rotational position signal, and transmits the actuator drive control signal to actuator 42 via output I/F 750. It is noted that, when the exercise request determination flag is turned on, for example, actuator driving unit 604 may drive actuator 42 such that the shift position is switched to the P position.

When roller 112 moves to location 124 of the P position, position signal updating unit 606 updates the position signal to be transmitted to power supply ECU 60, from the non-P position signal to the P position signal.

Vehicle speed determining unit 608 determines whether or not speed V of the vehicle is lower than predetermined speed α. Vehicle speed determining unit 608 determines whether or not speed V of the vehicle is lower than predetermined speed α, based on the vehicle speed signal received from power supply ECU 60 or VSC-ECU 56 via communication line 402. It is noted that vehicle speed sensor 64 is connected to input I/F 550 and vehicle speed determining unit 608 may receive the vehicle speed signal via input I/F 550. In addition, when determining that speed V of the vehicle is lower than predetermined speed α, for example, vehicle speed determining unit 608 may turn on the vehicle speed determination flag. Although a configuration is described in the present embodiment in which it is determined in SBW-ECU 50 whether or not speed V of the vehicle is lower than predetermined speed α, SBW-ECU 50 may receive, from power supply ECU 60, the result of the determination as to whether or not speed V of the vehicle is lower than predetermined speed α, for example.

When it is determined that the position signal is the P position signal and speed V of the vehicle is lower than predetermined speed α, completion/non-completion signal transmitting unit 610 transmits the auto-P completion signal to power supply ECU 60 via communicating unit 650 and communication line 402.

In addition, when the position signal is the non-P position signal or when speed V of the vehicle is higher than or equal to predetermined speed α, completion/non-completion signal transmitting unit 610 transmits the auto-P non-completion signal to power supply ECU 60.

It is noted that completion/non-completion signal transmitting unit 610 may transmit the auto-P completion signal to power supply ECU 60 when the position signal is the P position signal and the vehicle speed determination flag is ON, and may transmit the auto-P non-completion signal to power supply ECU 60 when the position signal is the non-P position signal or when the vehicle speed determination flag is OFF, for example.

Although, in the present embodiment, request determining unit 602, actuator driving unit 604, position signal updating unit 606, vehicle speed determining unit 608, and completion/non-completion signal transmitting unit 610 are all described as those functioning as software that are implemented by a CPU, which is processing unit 600, executing a program stored in storage unit 700, they may be implemented by hardware. It is noted that such program is stored in a recording medium and mounted on the vehicle.

Various information, a program, a threshold value, a map and the like are stored in storage unit 700, and read from processing unit 600 as required.

Although power supply ECU 60 and SBW-ECU 50 are described in the present embodiment as those configured by two electronic control units connected to allow bidirectional communication, power supply ECU 60 and SBW-ECU 50 may be configured by an integrated electronic control unit. In the present embodiment, power supply ECU 60 and SBW-ECU 50 simultaneously execute the programs stored in respective storage units 450 and 700.

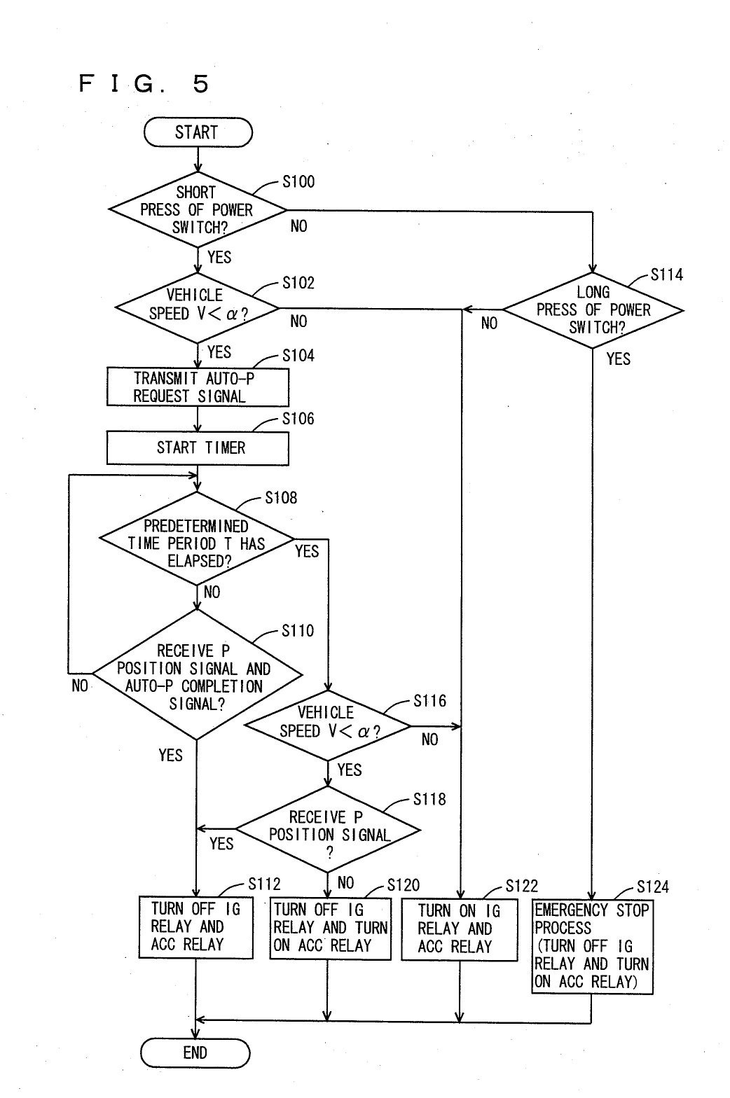

A control structure of the program running on power supply ECU 60 serving as the control device for the vehicle according to the present embodiment will be described hereinafter with reference to FIG. 5.

In step (that will be described as “S” hereinafter) 100, power supply ECU 60 determines whether or not power switch 62 is in the short pressed state. “Short press” corresponds to the operation state in which the time period during which the button serving as the input portion of power switch 62 is pressed is longer than predetermined time period (1) and shorter than predetermined time period (2). If power switch 62 is in the short pressed state (YES in S100), the process is moved to S102. If not (NO in S100), the process is moved to S114.

In S102, power supply ECU 60 determines whether or not speed V of the vehicle is lower than predetermined speed α. If speed V of the vehicle is lower than predetermined speed α (YES in S102), the process is moved to S104. If not (NO in S102), the process is moved to S122.

In S104, power supply ECU 60 transmits the auto-P request signal to SBW-ECU 50. In S106, power supply ECU 60 starts the timer. In S108, power supply ECU 60 determines whether or not the time period measured by the timer becomes longer than or equal to predetermined time period T. If predetermined time period T has elapsed (YES in S108), the process is moved to S116. If not (NO in S108), the process is moved to S110.

In S110, power supply ECU 60 determines whether or not to receive the P position signal and the auto-P completion signal from SBW-ECU 50. If the P position signal and the auto-P completion signal are received (YES in S110), the process is moved to S112. If not (NO in S110), the process is returned to S108.

In S112, power supply ECU 60 drives power supply relay 66 to turn off IG relay 68 and ACC relay 70.

In S114, power supply ECU 60 determines whether or not power switch 62 is in the long pressed state. “Long press” corresponds to the operation state in which the time period during which the button serving as the input portion of power switch 62 is pressed is longer than or equal to predetermined time period (3). If power switch 62 is in the long pressed state (YES in S114), the process is moved to S124. If not (NO in S114), the process is moved to S122.

In S116, power supply ECU 60 determines whether or not speed V of the vehicle is lower than predetermined speed α. If speed V of the vehicle is lower than predetermined speed α (YES in S116), the process is moved to S118. If not (NO in S116), the process is moved to S122.

In S118, power supply ECU 60 determines whether or not to receive the P position signal from SBW-ECU 50. If the P position signal is received (YES in S118), the process is moved to S112. If not (NO in S118), the process is moved to S120.

In S120, power supply ECU 60 drives power supply relay 66 to turn off IG relay 68 and maintain ACC relay 70 in the ON state.

In S122, power supply ECU 60 drives power supply relay 66 to maintain both IG relay 68 and AC relay 70 in the ON state.

In S124, power supply ECU 60 performs an emergency stop process. In other words, power supply ECU 60 drives power supply relay 66 to turn off IG relay 68, and forcibly stops engine 32.

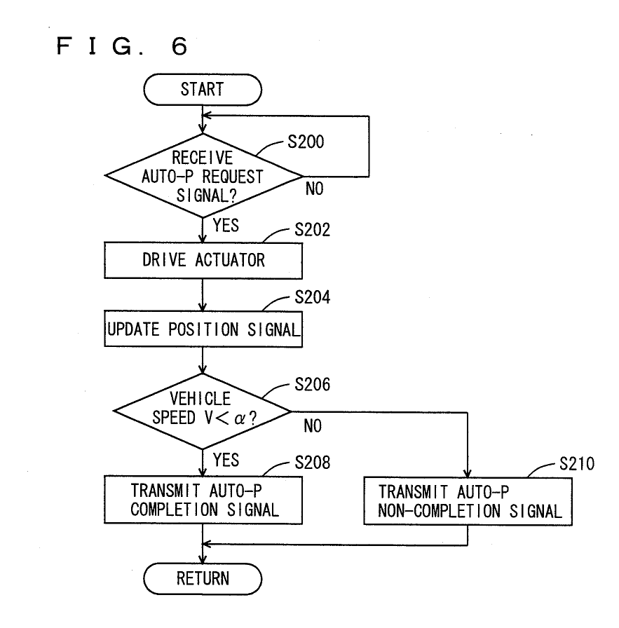

Next, a control structure of the program running on SBW-ECU 50 will be described with reference to FIG. 6.

In S200, SBW-ECU 50 determines whether or not to receive the auto-P request signal from power supply ECU 60. If the auto-P request signal is received (YES in S200), the process is moved to S202. If not (NO in S200), the process is returned to S200.

In S202, if the shift position is in the non-P position (e.g., if the position signal to be transmitted to power supply ECU 60 is the non-P position signal), SBW-ECU 50 drives actuator 42 such that roller 112 moves to the location of the P position. In S204, SBW-ECU 50 updates the position signal to be transmitted to power supply ECU 60, from the non-P position signal to the P position signal.

In S206, SBW-ECU 50 determines whether or not speed V of the vehicle is lower than predetermined speed α. If speed V of the vehicle is lower than predetermined speed α (YES in S206), the process is moved to S208. If not (NO in S206), the process is moved to S210.

In S208, SBW-ECU 50 transmits the auto-P completion signal to power supply ECU 60. In S210, SBW-ECU 50 transmits the auto-P non-completion signal to power supply ECU 60.

The operation of power supply ECU 60 and SBW-ECU 50 based on the above structures and flowcharts will be described.

It is assumed, for example, that the driver brings the vehicle to stop by operating the brake and the like while the vehicle is traveling on an inclined road surface (e.g., uphill road).

If the driver presses power switch 62 for a short time period to stop engine 32 (YES in S100), and if speed V of the vehicle is lower than predetermined speed α (YES in S102), the auto-P request signal is transmitted to SBW-ECU 50 (S104). Thereafter, the timer starts (S106).

If SBW-ECU 50 receives the auto-P request signal (YES in S200), actuator 42 is driven (S202). When the shift position is switched from the non-P position to the P position, the position signal is updated from the non-P position signal to the P position signal (S204).

<When Engine is Maintained in Actuated State>

When the driver presses power switch 62 for a short time period and eases press-down of the brake pedal, the braking force that acts on the vehicle by brake device 72 is lowered, and thus, the vehicle starts to move on the inclined road surface in the downward direction due to gravity before actuation of parking lock mechanism 200 is completed. Therefore, if speed V of the vehicle becomes higher than or equal to predetermined speed α (YES in S206), actuation of parking lock mechanism 200 cannot be completed and the auto-P non-completion signal is transmitted from SBW-ECU 50 to power supply ECU 60 (S210).

The P position signal and the auto-P completion signal are not received (NO in S110) until the time period measured by the timer becomes longer than or equal to predetermined time period T (NO in S108). Therefore, if predetermined time period T has elapsed (YES in S108), it is determined whether or not speed V of the vehicle is lower than predetermined speed α (S116).

If speed V of the vehicle increases to become higher than or equal to predetermined speed α with the press-down of the brake pedal eased (NO in S116), power supply relay 66 is driven to maintain both IG relay 68 and ACC relay 70 in the ON state (S122). Therefore, engine 32 is maintained in the actuated state. Since the pressure in the vacuum booster is maintained at the negative pressure by maintaining engine 32 in the actuated state, degradation in brake performance in brake device 72 is suppressed.

### When Actuation of Engine is Stopped (Example 1)

When the driver presses power switch 62 for a short time period and eases press-down of the brake pedal, the braking force that acts on the vehicle by brake device 72 is lowered, and thus, the vehicle starts to move on the inclined road surface in the downward direction due to gravity before actuation of parking lock mechanism 200 is completed. Therefore, if speed V of the vehicle becomes higher than or equal to predetermined speed α (YES in S206), actuation of parking lock mechanism 200 cannot be completed and the auto-P non-completion signal is transmitted from SBW-ECU 50 to power supply ECU 60 (S210).

The P position signal and the auto-P completion signal are not received (NO in S110) until the time period measured by the timer becomes longer than or equal to predetermined time period T (NO in S108). Therefore, if predetermined time period T has elapsed (YES in S108), it is determined whether or not speed V of the vehicle is lower than predetermined speed α (S116).

If speed V of the vehicle falls below predetermined speed α (YES in S116) by the driver's press-down of the brake pedal to increase the braking force that acts on the vehicle, before predetermined time period T has elapsed, it is determined whether or not to receive the P position signal.

When switching to the P position is completed, the position signal is updated from the non-P position to the P position. If power supply ECU 60 receives the P position signal (YES in S118), power supply relay 66 is driven to turn off IG relay 68 and ACC relay 70 (S112). At this time, actuation of engine 32 stops.

When switching to the P position is not completed, the position signal remains at the non-P position. If power supply ECU 60 does not receive the P position signal (NO in S118), power supply relay 66 is driven to turn off IG relay 68 and maintain ACC relay 70 in the ON state (S120). At this time, actuation of engine 32 stops. The location of the vehicle is fixed as a result of actuation of parking lock mechanism 200.

### When Actuation of Engine is Stopped (Example 2)

When the driver presses power switch 62 for a short time period and retains press-down of the brake pedal, the braking force that acts on the vehicle by brake device 72 is retained. At this time, if speed V of the vehicle is lower than predetermined speed α (YES in S206), parking lock mechanism 200 is actuated with the location of the vehicle fixed. It is determined that the location of the vehicle is in the fixed state, and the auto-P completion signal is transmitted from SBW-ECU 50 to power supply ECU 60 (S208).

If the P position signal and the auto-P completion signal are received (YES in S110) before the time period measured by the timer becomes longer than or equal to predetermined time period T (NO in S108), power supply relay 66 is driven to turn off IG relay 68 and ACC relay 70 (S112). Therefore, actuation of engine 32 stops. The location of the vehicle is fixed as a result of actuation of parking lock mechanism 200.

### When Actuation of Engine is Stopped (Example 3)

If the driver presses power switch 62 for a long time period (NO in S100, YES in S114), the emergency stop process is performed (S124). In other words, power supply relay 66 is driven to turn off IG relay 68 and maintain ACC relay 70 in the ON state (S124). At this time, actuation of engine 32 stops.

As described above, in the control device for the vehicle according to the present embodiment, even when the instruction to stop the engine is received, the engine is maintained in the actuated state if it is determined that the rotation of the parking lock gear is not limited. This allows suppression of engine stop before actuation of the parking lock mechanism is completed. Therefore, degradation in brake performance due to the engine stop can be suppressed. For example, even when the vehicle moves during parking of the vehicle on a road surface having an inclination and during actuation of the parking lock mechanism after the instruction to stop the engine is received as a result of short press of power switch 62, the location of the vehicle can be fixed by the driver's operation of the brake, to suppress the movement of the vehicle which is not intended by the driver. In addition, when actuation of the parking lock mechanism is completed, the movement of the vehicle can be adapted to the driver's intention by stopping the engine. Accordingly, there can be provided a control device for a vehicle and a method for controlling a vehicle that suppress the movement of the vehicle contrary to the driver's intention.

In addition, when the engine is at a standstill, degradation in performance of the brake using the negative pressure based on actuation of the engine can be suppressed by starting up the engine again.

It is noted that, when receiving the auto-P non-completion signal, the power supply ECU may provide a display for notifying the vehicle's occupant that the engine is maintained in the actuated state. It is noted that notification may be provided by an information transfer medium such as a sound, an image or a character. In addition to this, notification may also be provided by displaying information that encourages the driver to press down the brake pedal.

Although a configuration is described in the present embodiment in which it is determined whether or not the rotation of parking lock gear 108 is limited, based on speed V of the vehicle, the present invention is not particularly limited to the determination based on the speed of the vehicle.

For example, it may be determined whether or not the rotation of parking lock gear 108 is limited, by determining whether protrusion 208 of parking pole 106 meshes with the gear teeth of parking lock gear 108 or protrusion 208 of parking pole 106 does not mesh with the gear teeth of parking lock gear 108, based on an output signal from an angle sensor 74 provided at parking pole 106.

Alternatively, a voltmeter 76 and the like is used to detect electric power of a power supply 78 (e.g., a power storage mechanism such as a battery) that supplies electric power to actuator 42, and power supply ECU 60 may determine that the rotation of parking lock gear 108 is not limited, if the detected electric power is not electric power that allows driving of actuator 42.

It should be understood that the embodiments disclosed herein are illustrative and not limitative in any respect. The scope of the present invention is defined by the terms of the claims, rather than the above description, and is intended to include any modifications within the scope and meaning equivalent to the terms of the claims.

1.-24. (canceled)

25. A control device for a vehicle on which an internal combustion engine and a transmission provided with a parking lock mechanism are mounted, said parking lock mechanism switching between limitation of rotation of a driving wheel of said vehicle and release of the limitation by using a gear mechanism driven by an actuator based on an electrical signal corresponding to a state of an operation member, said actuator being driven by receiving electric power feed from a power supply, said control device comprising:
a speed detecting unit for detecting a speed of said vehicle;
an actuation state detecting unit for detecting a physical amount related to an actuation state of said parking lock mechanism ; and
a control unit for receiving outputs from said actuation state detecting unit and said speed detecting unit,
said control unit
determining whether or not an instruction to stop said internal combustion engine has been received, based on said electrical signal,
controlling said actuator such that the rotation of said driving wheel is limited by said parking lock mechanism, when receiving the instruction to stop said internal combustion engine,
determining whether or not the rotation of said driving wheel is limited based on said physical amount detected, when receiving the instruction to stop said internal combustion engine,
maintaining said internal combustion engine in an actuated state, when determining that the rotation of said driving wheel is not limited by said parking lock mechanism and when said speed of the vehicle is higher than or equal to a predetermined speed,
stopping said internal combustion engine and maintaining the electric power feed from said power supply to said actuator, when determining that the rotation of said driving wheel is not limited by said parking lock mechanism and when said speed of the vehicle is lower than said predetermined speed, and
stopping said internal combustion engine and stopping the electric power feed from said power supply to said actuator, when determining that the rotation of said driving wheel is limited by said parking lock mechanism.

26. The control device for a vehicle according to claim 25, wherein
said parking lock mechanism includes a gear provided at a shaft coupled to said driving wheel, and a member for limiting rotation of said gear or releasing limiting rotation of said gear,
said actuation state detecting unit detects a location of said member, and
said control unit determines that the rotation of said driving wheel is not limited, when said location detected is not a location where the rotation of said gear is limited.

27. The control device for a vehicle according to claim 25, wherein
said actuator is a rotating electric machine driven by receiving the electric power feed from said power supply,
said actuation state detecting unit detects the electric power of said power supply, and
said control unit determines that the rotation of said driving wheel is not limited, when said electric power detected is not electric power that allows driving of said actuator.

28. The control device for a vehicle according to claim 25, further comprising
a notifying unit for notifying an occupant of said vehicle that said internal combustion engine is maintained in the actuated state, when it is determined that the rotation of said driving wheel is not limited.

29. The control device for a vehicle according to claim 25, wherein
said control unit
determines whether or not an instruction to forcibly stop said internal combustion engine has been received, based on said electrical signal, and
stops said internal combustion engine when receiving the instruction to forcibly stop said internal combustion engine.

30. The control device for a vehicle according to claim 25, wherein
the state of said operation member is a state based on a time period during which operation of said operation member continues.

31. The control device for a vehicle according to claim 25, further comprising
a traveling state detecting unit for detecting a traveling state of said vehicle, wherein
said control unit
receives an output from said traveling state detecting unit,
determines whether or not said vehicle is at a standstill, based on said traveling state detected, and
stops said internal combustion engine when determining that the rotation of said driving wheel is not limited and said vehicle is at a standstill.

32. The control device for a vehicle according to claim 31, wherein
said traveling state detecting unit detects a speed of said vehicle, and
said control unit determines that said vehicle is at a standstill, when said speed of the vehicle detected is lower than a predetermined speed after a predetermined time period has elapsed from a point in time when the instruction to stop said internal combustion engine was received.

33. The control device for a vehicle according to claim 25, wherein
said parking lock mechanism includes
a parking lock gear provided at a shaft coupled to said driving wheel and having a gear tooth along a direction of rotation,
a parking lock pole supported by a case of said transmission and having a protrusion that meshes with said gear tooth, and
a limiting unit for limiting the rotation of said driving wheel by meshing said gear tooth and said protrusion of said parking lock pole in accordance with driving of said actuator.

34. The control device for a vehicle according to claims 25, wherein
a brake device for producing braking force by using a negative pressure generated as a result of actuation of said internal combustion engine when said internal combustion engine is actuated is mounted on said vehicle.

35. A method for controlling a vehicle on which an internal combustion engine and a transmission provided with a parking lock mechanism are mounted, said parking lock mechanism switching between limitation of rotation of a driving wheel of said vehicle and release of the limitation by using a gear mechanism driven by an actuator based on an electrical signal corresponding to a state of an operation member, said actuator being driven by receiving electric power feed from a power supply, said method for controlling a vehicle comprising the steps of:
detecting a speed of said vehicle;
detecting a physical amount related to an actuation state of said parking lock mechanism;
determining whether or not an instruction to stop said internal combustion engine has been received, based on said electrical signal;
controlling said actuator such that the rotation of said driving wheel is limited by said parking lock mechanism, when the instruction to stop said internal combustion engine has been received;
determining whether or not the rotation of said driving wheel is limited based on said physical amount detected, when the instruction to stop said internal combustion engine has been received;
maintaining said internal combustion engine in an actuated state, when it is determined that the rotation of said driving wheel is not limited by said parking lock mechanism and when said speed of the vehicle is higher than or equal to a predetermined speed;
stopping said internal combustion engine and maintaining the electric power feed from said power supply to said actuator when it is determined that the rotation of said driving wheel is not limited by said parking lock mechanism and when said speed of the vehicle is lower than said predetermined speed; and
stopping said internal combustion engine and stopping the electric power feed from said power supply to said actuator, when it is determined that the rotation of said driving wheel is limited by said parking lock mechanism.

36. The method for controlling a vehicle according to claim 35, wherein
said parking lock mechanism includes a gear provided at a shaft coupled to said driving wheel, and a member for limiting rotation of said gear or releasing the limitation,
in said step of detecting a physical amount related to an actuation state of said parking lock mechanism, a location of said member is detected, and
in said step of determining whether or not the rotation of said driving wheel is limited, it is determined that the rotation of said driving wheel is not limited, when said location detected is not a location where the rotation of said gear is limited.

37. The method for controlling a vehicle according to claim 35, wherein
said actuator is a rotating electric machine driven by receiving the electric power feed from said power supply,
in said step of detecting a physical amount related to an actuation state of said parking lock mechanism, the electric power of said power supply is detected, and
in said step of determining whether or not the rotation of said driving wheel is limited, it is determined that the rotation of said driving wheel is not limited, when said electric power detected is not electric power that allows driving of said actuator.

38. The method for controlling a vehicle according to claim 35, further comprising the step of
notifying an occupant of said vehicle that said internal combustion engine is maintained in the actuated state, when it is determined that the rotation of said driving wheel is not limited.

39. The method for controlling a vehicle according to claim 35, further comprising the steps of:
determining whether or not an instruction to forcibly stop said internal combustion engine has been received, based on said electrical signal, and
stopping said internal combustion engine when the instruction to forcibly stop said internal combustion engine has been received.

40. The method for controlling a vehicle according to claim 35, wherein
the state of said operation member is a state based on a time period during which operation of said operation member continues.

41. The method for controlling a vehicle according to claim 35, further comprising the steps of:
detecting a traveling state of said vehicle;
determining whether or not said vehicle is at a standstill, based on said traveling state detected; and
stopping said internal combustion engine when it is determined that the rotation of said driving wheel is not limited and said vehicle is at a standstill.

42. The method for controlling a vehicle according to claim 41, wherein
in said step of detecting a traveling state of said vehicle, a speed of said vehicle is detected, and
in said step of determining whether or not said vehicle is at a standstill, it is determined that said vehicle is at a standstill, when said speed of the vehicle detected is lower than a predetermined speed after a predetermined time period has elapsed from a point in time when the instruction to stop said internal combustion engine was received.

43. The method for controlling a vehicle according to claim 25, wherein
said parking lock mechanism includes
a parking lock gear provided at a shaft coupled to said driving wheel and having a gear tooth along a direction of rotation,
a parking lock pole supported by a case of said transmission and having a protrusion that meshes with said gear tooth, and
a limiting unit for limiting the rotation of said driving wheel by meshing said gear tooth and said protrusion of said parking lock pole in accordance with driving of said actuator.

44. The method for controlling a vehicle according to claims 25, wherein
a brake device for producing braking force by using a negative pressure generated as a result of actuation of said internal combustion engine when said internal combustion engine is actuated is mounted on said vehicle.
